(19) United States
(12) Patent Application Publication
(10) Pub. No.: US 2022/0274050 A1
(43) Pub. Date: Sep. 1, 2022

(54) METHOD FOR TREATING GAS BY ADSORPTION USING THERMALLY OPTIMISED HOT FLASH SOLVENT REGENERATION

(71) Applicant: IFP Energies Nouvelles, Rueil-Malmaison Cedex (FR)

(72) Inventor: Vincent CARLIER, Rueil-Malmaison Cedex (FR)

(73) Assignee: IFP Energies Nouvelles, Rueil-Malmaison Cedex (FR)

(21) Appl. No.: 17/632,850

(22) PCT Filed: Jul. 29, 2020
(86) PCT No.: PCT/EP2020/071331

§ 371 Date: Feb. 4, 2022

(30) Foreign Application Priority Data
Aug. 8, 2019 (FR) FR1909063

(51) Int. Cl. B01D 53/14; B01D 53/18; B01D 53/62; B01D 53/78; B01D 53/96

(52) U.S. Cl. CPC B01D 53/1425; B01D 53/18; B01D 53/62; B01D 53/1475; B01D 53/78; B01D 53/96; B01D 2252/20426; B01D 2252/20431; B01D 2257/504

(57) ABSTRACT

The invention concerns a plant and a method for treating gas by chemical, physical or hybrid absorption of compounds for removal, comprising at least:
a) a step of absorption by contacting a gas for treatment with a depleted solvent to give a treated gas and a rich solvent;
b) a step of optional separation by medium-pressure flashing
c) a step of heat exchange between a fraction of the cold rich solvent and the hot depleted solvent in a first heat exchanger
d) a step of heat exchange between the complementary fraction of the cold rich solvent and a hot gaseous effluent in a second exchanger
e) a step of optional separation by low-pressure flashing
f) a step of regeneration of the rich solvent by heating in a reboiler
g) a step of separation by low-pressure flashing
h) a cooling of the depleted solvent.

### TECHNICAL FIELD

The present invention relates to the field of gas treatment, the present invention pertaining more particularly to a method for treating gas by absorption (chemical, physical or hybrid) using hot flash solvent regeneration. This type of regeneration is commonly limited to applications for which partial regeneration of the solvent is deemed sufficient for meeting the specifications for the treated gas.

The target fields are thus essentially instances of decarbonation (natural gas, biogas, syngas, CO₂ capture from industrial flue gases from incinerators, coal power stations, blast furnaces, etc.).

Instances involving what are termed stringent specifications (H₂S, COS, mercaptans, SOₓ, NOₓ, etc.) generally necessitate the installation of more high-level regeneration of the solvent by steam entrainment effect (more habitually called steam stripping, viz. a process for extracting volatile compounds by entrainment using an inert gas) in a regenerator to reach the required quality of depleted solvent. The hot flash regeneration mode generally proves unsuitable for these instances.

### PRIOR ART

A plant for treating gas by absorption with a solvent, preferably with amines, consists conventionally of two chemical reactors: the absorber and the regenerator. In the absorber, the downward flow of solvent meets the upward flow of a gaseous mixture and combines with the acidic gases contained therein. The “sweetened” gaseous mixture exits the absorber freed of its compounds for removal, and the “rich” solvent carries with it the acidic gases. In the regenerator, the rich solvent can be regenerated by stripping, i.e., heated successively in a stripper (evaporator) and a boiler to evacuate acid-rich vapors, or be regenerated by hot flashing, i.e., pass directly into the reboiler, then undergo hot flashing to free it of the desorbed gaseous compounds. The solvent, “depleted” of acidic gases, is cooled by the rich solvent from the absorber. The cold depleted solvent can then go back into the absorber in order to scrub the gas.

Like any process, the challenges for methods for treating gas by absorption are the capital expenditures for the plant (CAPEX) and the operating expenditures (OPEX). The absorption processes that use simple hot flash regeneration are known to those skilled in the art and go part way to meeting these challenges: by comparison with the process entailing regeneration by stripping, the capital expenditure is limited (no regeneration column, for a start) and the energy consumed by the process (reboiler power) can be reduced substantially (this being the main item in the operating expenditures for the process).

The hot flash regeneration mode is generally limited to fields of application for which lower-level regeneration of the solvent is sufficient. Alternatively expressed, very low residual amounts of acidic gases (CO₂, H₂S) in the depleted solvent are not needed in order to meet the target specifications in the treated gas (in the case of decarbonation with a relaxed specification: natural gas, biogas, CO₂ capture from industrial flue gases, etc.).

The thermal integration associated with this hot flash regeneration mode is generally limited. It takes the form of the installation of a feedstock/effluent heat exchanger allowing the cold rich solvent from the absorption section to be reheated from the hot depleted solvent exiting the regeneration section. An example is given in FIG. 2 (detailed later on in the description) for the scenario of decarbonation of a natural gas with the aim of a gas pipeline specification (generally 2.5 vol % CO₂). In this example, the heat energy in the hot, water-saturated CO₂ effluent from the regeneration section is not usefully employed. The heat from cooling of the gaseous effluent is commonly dissipated using cooling towers or water coolers.

For biogas cleaning applications, Hitachi Zosen Inova (HZI) proposes recovering the heat from the CO₂ effluent and also the heat from the hot depleted solvent (see FIG. 3, described in detail later on in the description). The proposed arrangement of exchangers is not deemed optimal, however. The reason is that the siting of the CO₂/rich solvent exchanger as described (i.e., upstream of the rich solvent/depleted solvent exchanger) reduces heat recovery from the depleted solvent and hence is detrimental to the thermal integration of the process.

Document WO 2019/053367 (Air Liquide) proposes in turn, likewise for biogas cleaning applications, the use of a heat pump (HP) to reduce the thermal consumption in the process. However, there are substantial increases in the electricity consumption of the process and the capital expenditure for the plant (owing to the compressor of the heat pump).

It is therefore seen that to date there has been no entirely satisfactory solution to the following problems: substantially reducing the thermal consumption in an absorption process while not increasing the electricity consumption and the capital expenditure for the plant.

The present invention responds to this technical problem by proposing hot flashing for solvent regeneration, combined with a modified thermal integration. The invention is described in detail hereinafter.

In the description below, the term “heat exchanger” or more simply “exchanger” refers to any device allowing the transfer of thermal energy from one fluid to another without the fluids being mixed. The heat exchange may take place indirectly, via an exchange surface separating the fluids. In this case, the heat flow crosses the exchange surface that separates the fluids.

In the description below, unless otherwise indicated, the pressure is an absolute pressure expressed in bar.

### SUMMARY OF THE INVENTION

The invention concerns a method for treating gas by chemical, physical or hybrid absorption of compounds for removal, comprising at least:
a) a step of absorption of said compounds for removal in an absorber 1 by contacting a stream of gas for treatment 101 with a solvent stream at a temperature of preferably between 20 and 60° C., called “depleted solvent” 117, to give a treated gas 102 and a solvent enriched in compounds for removal, called “rich solvent” 103;
b) a step of optional separation of the rich solvent 103 in a medium-pressure flash vessel 2 to desorb the coabsorbed compounds 106 and give a cold rich solvent 104 at a temperature preferably of between 40 and 80° C.;
c) a step of heat exchange between a fraction 104A of the cold rich solvent stream 104 and the hot depleted solvent stream 110 in a heat exchanger 3A to give a reheated rich solvent stream 105A, at a temperature preferably of between 60 and 170° C., very preferably between 100 and 130° C., and a cooled depleted solvent stream 115 at a temperature preferably of between 45 and 90° C., very preferably between 60 and 90° C.;
d) a step of heat exchange between the complementary fraction 104B of the cold rich solvent stream 104 and the hot desorbed gas effluent 112 corresponding to the desorbed gas stream 111 from the flash separation in step g) and to the gaseous compound stream 107 from the optional flash separation in step e) in a heat exchanger 3B to give a reheated rich solvent stream 105B at a temperature preferably of between 60 and 170° C., very preferably between 100 and 130° C., and a cooled desorbed gas stream 113 at a temperature preferably of between 45 and 90° C., very preferably between 60 and 90° C.;
e) a step of optional separation in a low-pressure flash vessel 4 of the reheated rich solvent streams 105A and 105B at the exit of the thermal integration steps, enabling the separation of the gaseous compounds 107 at a temperature preferably of between 60 and 170° C., very preferably between 100 and 130° C., and a rich solvent stream 108, at a temperature preferably of between 60 and 170° C., very preferably between 100 and 130° C.;
f) a step of regeneration of the rich solvent 108 by heating in a reboiler 5 at a temperature preferably of between 70 and 180° C. to give a biphasic regenerated solvent 109;
g) a step of separation in a low-pressure flash vessel 6 of the biphasic regenerated solvent 109, enabling the separation of a hot depleted solvent stream 110 at a temperature preferably of between 70 and 180° C., very preferably between 110 and 140° C., and a gaseous stream comprising the compounds for removal in desorbed gas form 111, at a temperature preferably of between 70 and 180° C., very preferably between 110 and 140° C.;
h) a final cooling of the cooled depleted solvent 115 to give a fully cooled depleted solvent stream 116 at a temperature preferably of between 20 and 60° C. ready to be fed again to the absorber 1 in the form of a depleted solvent stream 117.

The fraction 104A of the cold rich solvent stream sent to the heat exchanger 3A may represent between 0.5% and 50% by weight, preferably between 5% and 40% by weight of the total rich solvent stream.

The separation in the medium-pressure flash vessel in step b) may be performed at a higher pressure than the separation in the low-pressure flash vessel, of between 3 and 10 bar, preferably between 5 and 10 bar, very preferably between 5 and 7 bar.

The separation in the low-pressure flash vessel in steps e) and g) may be performed at a pressure of between 0 and 9 bar, preferably between 1 and 4 bar.

In one embodiment, the separation in the low-pressure flash vessels in steps e) and g) is performed at the same pressure of between 1 and 4 bar and the separation in the medium-pressure flash vessel in step b) is performed at a pressure of between 5 and 10 bar.

In one embodiment, the heating in the reboiler in step f) and the separation in the low-pressure flash vessel in step g) are performed at a pressure strictly of between 0 and 1 bar. The temperature in the reboiler in that case is between 70 and 100° C.

In another embodiment, the operating pressure in the reboiler is between 1 and 9 bar, preferably between 1 and 4 bar, and the temperature in the reboiler is between 100 and 140° C., preferably between 110 and 140° C.

The solvent may be a chemical solvent comprising at least one amine.

The solvent preferably comprises a mixture of tertiary and secondary amines.

The method may comprise a step i) of final condensation of the desorbed gas stream 113 with the aim of limiting the water losses in the method, so as to give a stream 114 of cooled desorbed compounds, at a temperature of preferably between 20 and 60° C.

The operating pressure in the absorption step a) may be between 1 and 80 bar.

The gas for treatment may be selected from a biogas, a natural gas, a synthesis gas (syngas), or industrial flue gases, for example coal power station, incinerator or blast furnace flue gases.

The invention also concerns a gas treatment plant allowing implementation of the method according to the invention, comprising at least:
an absorber 1 allowing the gas for treatment to be contacted with a solvent referred to as “depleted solvent” to give a treated gas and solvent enriched in compounds for removal, called “rich solvent”
an optional vessel 2 for medium-pressure flashing of the rich solvent to desorb the coabsorbed compounds
a cold rich solvent/hot depleted solvent heat exchanger 3A
a cold rich solvent/hot gas effluent heat exchanger 3B
a conduit for short-circuiting a fraction of the cold rich solvent fed to the cold rich solvent/hot depleted solvent heat exchanger 3A to the cold rich solvent/hot gas effluent heat exchanger 3B
an optional low-pressure flash vessel 4 at the exit of the thermal integration steps, enabling the degassing of the rich solvent
a reboiler 5 enabling heating of the rich solvent
a low-pressure flash vessel 6, enabling separation of the regenerated solvent and the compounds for removal in desorbed gas form
an optional final condenser 7 for the desorbed gases, with the aim of limiting the water and solvent losses in the method
a final cooler 8 for the depleted solvent
a set of pumps for (depleted and/or rich) solvent 9, enabling the circulation of the solvent.

The heat exchanger 3A and the heat exchanger 3B may consist of one and the same apparatus.

### LIST OF FIGURES

Other features and advantages of the method and of the plant according to the invention will become apparent on a reading of the following description of nonlimiting exemplary embodiments with reference to the appended FIGS. 1 and 4 described below.

FIG. 1 represents a schematic diagram of the method according to the invention (using the example of decarbonation of a natural gas).

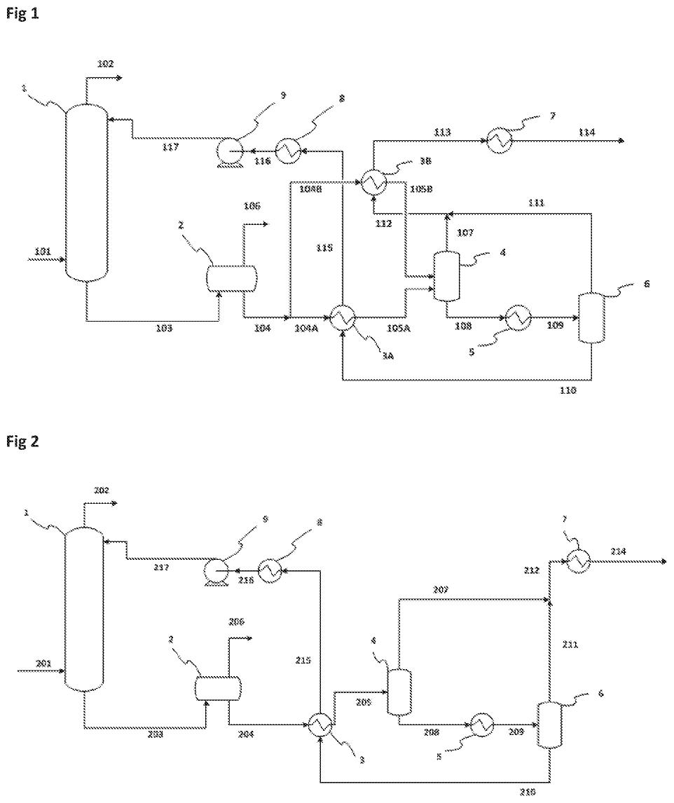

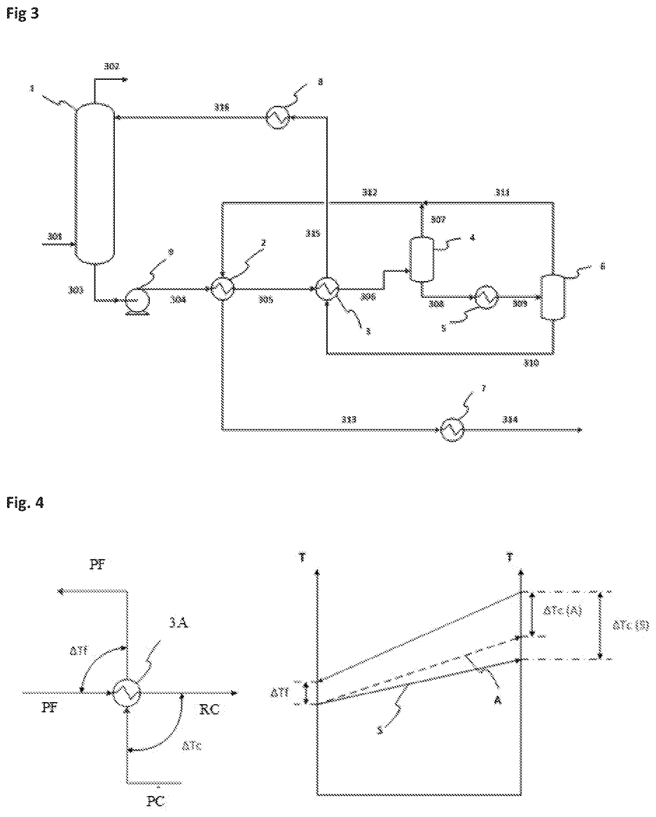

The method proposed according to the invention (FIG. 1) involves treating a gas by absorption in a physical, chemical or hybrid solvent—hybrid meaning a mixture of physical and chemical solvent—utilizing a hot flash solvent regeneration and comprising at least the following steps:
a step of absorption of the compounds for removal in an absorber 1 enabling contact between the gas for treatment and the depleted solvent
a step of optional separation of the rich solvent by medium-pressure flashing MP in a vessel 2 with the aim of desorbing the coabsorbed compounds (typically hydrocarbons in natural gas treatment applications)
a step of thermal integration employing a cold rich solvent/hot depleted solvent heat exchanger 3A
a step of thermal integration employing a cold rich solvent/hot gas effluent heat exchanger 3B
sampling of a fraction of cold rich solvent stream from the cold rich solvent/hot depleted solvent heat exchanger
separation in an optional low-pressure flash LP vessel 4 at the exit of the thermal integration steps, enabling the degassing of the rich solvent
a step of regeneration by passing of the rich solvent into a reboiler 5 with the aim of heating the solvent to regenerate the solvent to the required quality, followed by separation in a low-pressure flash LP vessel 6, enabling separation of the regenerated solvent and the compounds for removal in desorbed gas form
an optional final condensation for the desorbed gases in a final condenser 7 with the aim of limiting the water and solvent losses in the method
final cooling of the depleted solvent in a cooler 8
the circulation of the solvent between the absorption and regeneration sections, by virtue of a set of (depleted and/or rich) solvent pumps 9. The number and location of the pumps in the solvent loop may vary by the type of application (dependent on the operating pressures of the absorption and regeneration sections).

FIG. 2 represents an absorption method with hot flash regeneration as conventionally used for decarbonating a natural gas, using a rich solvent/depleted solvent exchanger.

The prior art method comprises a step of absorption of the compounds for removal from said natural gas in an absorber 1 by contacting a natural gas stream for treatment 201 with a solvent stream called “depleted solvent” 217 to give a treated gas 202 and a solvent enriched in compounds for removal, called “rich solvent” 203, an optional step of flashing the rich solvent 203 in a medium-pressure vessel 2 to desorb the coabsorbed compounds 206 and give a cold rich solvent 204, a step of heat exchange between the cold rich solvent 204 and the hot depleted solvent stream 210 in an exchanger 3 to give a reheated rich solvent stream 205 and a cooled depleted solvent stream 215; an optional flash separation 4 enabling separation of the gaseous compounds 207 and a rich solvent stream 208; regeneration of the rich solvent 208 in a reboiler 5 to give a regenerated solvent in biphasic form 209; a low-pressure flash separation 6 on the regenerated solvent, enabling separation of a regenerated solvent stream freed from desorbed gases, or “hot depleted solvent” 210, and a desorbed gas stream 211; the “hot depleted solvent” 210 enters a heat exchanger 8 to be cooled, forming a cold depleted solvent 216; a pump 9 may optionally be used to feed the solvent termed “depleted solvent” 217 at the inlet of the absorber 1.

A final condensation of the gaseous compounds 207 and 211 which form a stream 212 sent to a condenser 7 to form a gas stream 214; final cooling of the cooled depleted solvent 215 to give a fully cooled depleted solvent stream 216 ready to feed the absorber 1 again, in the form of a depleted solvent stream 217 by means of the solvent circulation pump 9.

FIG. 3 represents a prior art absorption method with hot flash regeneration as proposed by Hitachi Zosen Inova (HZI) for the cleaning of a biogas (removal of CO₂).

The method proposed according to the prior art thus comprises a step of absorption of the compounds for removal from said biogas in an absorber 1 by contacting a stream of biogas for treatment 301 with a solvent stream called “depleted solvent” 316, to give a treated gas 302 (biomethane) and a solvent enriched in compounds for removal, called “rich solvent” 303. The rich solvent stream 303 is sent by means of a solvent circulation pump 9 to a rich solvent/gas effluent heat exchanger 2, where it exchanges heat with the gas stream 312 formed of the gaseous streams 311 from a low-pressure flash vessel and of the gaseous stream 307 from an optional low-pressure flash step 4, to give a cooled gaseous effluent 313 which is sent to a condenser 7 to form the gas outlet stream 314 (CO₂ effluent), and a reheated rich solvent stream 305 which is sent to a rich solvent/depleted solvent heat exchanger 3. The stream emerging therefrom is a hot rich solvent stream 306 which is sent to a flash separation 4 enabling separation of the gaseous compounds 307 and a rich solvent stream 308.

The rich solvent stream 308 is sent to a reboiler 5 enabling regeneration of the rich solvent by heating, to give a biphasic regenerated solvent 309.

The regenerated solvent 309 is then sent to a low-pressure flash separation 6, which allows separation of a regenerated solvent or “hot depleted solvent” stream 310 and a desorbed gas stream 311.

The gaseous compounds 307 and 311 form the stream 312 which feeds the rich solvent/gas effluent heat exchanger 2.

Final cooling of the cooled depleted solvent 315 takes place in a cooler 8 to give a fully cooled depleted solvent stream 316 ready to feed the absorber 1 again.

FIG. 4 represents the hot and cold temperature approximation concepts in a rich solvent/depleted solvent exchanger 1 with (A) and without (S) sampling of a fraction of solvent (bypass) on the cold side.

### DESCRIPTION OF EMBODIMENTS

The invention also concerns a gas treatment plant (FIG. 1) allowing implementation of the method according to the invention, comprising at least:
an absorber 1 allowing the gas for treatment to be contacted with a solvent referred to as “depleted solvent” to give a treated gas and solvent enriched in compounds for removal, called “rich solvent”
an optional vessel 2 for medium-pressure flashing of the rich solvent to desorb the coabsorbed compounds
a cold rich solvent/hot depleted solvent heat exchanger 3A
a cold rich solvent/hot gas effluent heat exchanger 3B
a conduit (bypass) for short-circuiting a fraction of the cold rich solvent feeding the cold rich solvent/hot depleted solvent heat exchanger 3A to the cold rich solvent/hot gas effluent heat exchanger 3B
an optional low-pressure flash vessel 4 at the exit of the thermal integration steps, enabling the degassing of the rich solvent
a reboiler 5 intended for heating and regenerating the solvent to the required quality
a low-pressure flash vessel 6, enabling separation of the regenerated solvent and the compounds for removal in desorbed gas form
an optional final condenser for the desorbed gases 7 with the aim of limiting the water and solvent losses in the method
a final cooler for the depleted solvent 8
a set of pumps for (depleted and/or rich) solvent 9, enabling the circulation of the solvent between the absorption and regeneration sections.

The hot flash regeneration section of the present invention comprises at least the reboiler 5 and the low-pressure flash vessel 6 and is integrated thermally with the absorption section comprising the absorber 1 by means of the heat exchangers 3A and 3B.

The gas treatment method according to the invention (FIG. 1) employs a step a) of absorption of the compounds for removal from said gas in an absorber 1 by contacting a stream of gas for treatment 101 with a solvent stream which is pure or highly depleted in compounds for removal, called “depleted solvent” 117, to give a treated gas 102 and a solvent enriched in compounds for removal, called “rich solvent” 103. The operating conditions in the absorption step are generally as follows: the pressure is generally between 1 and 80 bar; for a natural gas treatment application generally between 30 and 80 bar, and for a flue gas CO₂ capture or biogas cleaning application generally between 1 and 2 bar.

The temperature of the depleted solvent is often dependent on the temperature of the gas for treatment and the cold utilities available, and is generally between 20 and 60° C.

Optionally, a step b) of medium-pressure flash separation (advantageously conducted at a pressure of between 5 and 10 bar, depending on the end use of the gas from the medium-pressure flash) of the rich solvent 103 in a vessel 2 may allow desorption of the coabsorbed compounds 106 and production of a cold rich solvent stream 104. Absent this step, the cold rich solvent stream 104 is identical to the rich solvent stream 103. The temperature of the cold rich solvent 104 depends advantageously on the quantity of gas absorbed and on the temperature of the depleted solvent and the gas to be treated, and may be between 40 and 80° C.

Next, via an exchange of heat c) between a fraction 104A of the cold rich solvent stream 104 and the hot depleted solvent stream 110 in an exchanger 3A, it is possible to obtain a reheated rich solvent stream 105A and a cooled depleted solvent stream 115. The reheated rich solvent 105A generally has a temperature of between 60 and 170° C., preferably between 100 and 130° C.; the cooled depleted solvent 115 generally has a temperature of between 45 and 90° C., preferably between 60 and 90° C.

At the same time, a step of heat exchange d) between the complementary fraction 104B of the cold rich solvent stream and the hot desorbed gas effluent 112 corresponding to the desorbed gas stream 111 from the flash separation in step g) and to the gaseous compound stream 107 from the optional flash separation in step e) in a heat exchanger 3B to give a reheated rich solvent stream 105B (the reheated rich solvent 105B generally has a temperature of between 60 and 170° C., preferably between 100 and 130° C.) and a cooled desorbed gas stream 113 at a temperature generally of between 45 and 90° C., preferably between 60 and 90° C.

A low-pressure flash separation step e) 4 may optionally be conducted at the exit from the thermal integration steps, allowing a first separation of the compounds for removal.

Absent this step, the rich solvent stream 108 sent to the reboiler 5 is the sum of the reheated rich solvent streams 105A and 105B.

The method also comprises a step of regeneration f) of the rich solvent 108 by heating in a reboiler 5 at a temperature generally of between 70 and 180° C. depending on the operating pressure selected, preferably between 100 and 140° C., very preferably between 110 and 140° C., to give a biphasic regenerated solvent 109 comprising the compounds for removal in desorbed gas form, followed by a step g) of separation by low-pressure flash 6, enabling the separation of a “hot depleted solvent” stream 110 at a temperature generally of between 70 and 180° C., preferably between 110 and 140° C., and a desorbed gas stream 111, at the same temperature of generally between 70 and 180° C., preferably between 110 and 140° C. Steps f) and g) enable the hot flash regeneration of the solvent.

The method also comprises a step h) of final cooling of the cooled depleted solvent 115 to give a fully cooled depleted solvent stream 116 ready to be fed again to the absorber 1 in the form of a depleted solvent stream 117 at a temperature generally of between 20 and 60° C. depending on the temperature of the gas for treatment 101 and the cold utilities available. The method may optionally comprise a step i) of final condensation of the desorbed gas stream 113 from the rich solvent/gas effluent exchanger 3B with the aim of limiting the water losses in the method, allowing a stream 114 of cooled desorbed compounds for removal, generally at a temperature of between 20 and 60° C. depending on the cold utilities available.

At the heart of the present invention, therefore, is the implementation of a sampling of a fraction 104B of the rich solvent stream on the cold side of the cold rich solvent/hot depleted solvent heat exchanger 3A, combined with a modified thermal integration using the heat energy of the desorbed gas streams (107 and 111).

Without this sampling of a fraction of the cold rich solvent stream (bypass), the rich solvent (cold RF, hot RC)/depleted solvent (hot PC, cold PF) exchanger 3A (FIG. 4) would exhibit a narrowing in temperature on the cold side: the temperature approximation on the cold side (referenced ΔT_{f}), generally between 5 and 20° C. depending on application and on exchanger technology, would be smaller than the temperature approximation on the hot side (referenced ΔT_{c}). This is explained simply by the change in phase of the rich solvent flowing in the cold vein of the exchanger (desorption of absorbed gases and evaporation of the solvent). The depleted solvent flowing in the hot vein of the exchanger is cooled, giving up only its sensible heat to the cold rich solvent (no change in state). In FIG. 4, the difference in temperature on the cold side (ΔTf) is much lower than the temperature difference on the hot side, without thermal integration by means of the short-circuit conduit (ΔTc, see curve S). Owing to the presence of the short-circuit conduit, which sends a fraction of the cold rich solvent to the exchanger 3B, this imbalance between cold side and hot side can be reduced (see curve A).

The reason is that the only means of rebalancing the cold and hot temperature approximations in the rich solvent/depleted solvent exchanger 3A is to divert (bypass) a fraction of the volume flow of cold solvent sent to said exchanger. This fraction of cold rich solvent stream 104B may conversely be heated by the hot desorbed gases 111 and possibly 107 obtained respectively from flash separation steps 4 and 6. Using the stream 111, and optionally the stream 107, enables thermal integration of the method.

The thermal integration envisaged thus enables a substantial increase in the temperature of the rich solvent at the outlet of the exchangers 3A and 3B. This increase in temperature translates into greater evaporation of the rich solvent, and the direct consequence is a reduction in the energy consumption of the reboiler 5. Substantial gains in terms of energy consumption can be made, of the order of 20 to 40%, according to scenario.

The diverted volume flow fraction of rich solvent 104B may represent 0.5 to 50%, preferably from 5 to 40% of the total volume flow of rich solvent, depending on application, on the degree of loading of the rich solvent (expressed as moles of acidic gases/mole of solvent) and on the technology of the exchangers 3A and 3B. The diverted fraction is adjusted so as to balance the temperatures of the two rich solvent streams 105A and 105B exiting the exchangers 3A and 3B.

From a technological standpoint, the heat exchangers 3A and 3B may be two physically separate exchangers or a sole, single exchanger having a multiplicity of feeds and outlets (of plate exchanger type).

The separation by low-pressure flashing in steps e) and g) is performed at a pressure generally of between 0 and 9 bar, preferably between 1 and 4 bar.

The separation by medium-pressure flashing in step b) is performed at a higher pressure than the low-pressure separation, at a pressure generally of between 3 and 10 bar, preferably between 5 and 10 bar, very preferably between 5 and 7 bar.

According to one preferred mode of the device, the flash vessels 4 and 6 operate at the same pressure (except for load losses in the circuit). The operating pressure of the LP flash vessels 4 and 6 is advantageously between 1 and 4 bar. The upper limit is generally defined as a function of the thermal degradation of the solvent used. The operating pressure of the MP flash vessel 2 is advantageously between 5 and 10 bar.

The temperature needed in the reboiler 5 is generally between 70 and 180° C. depending on operating pressure. Advantageously, when the pressure is greater than 1 bar, the temperature in the reboiler is between 100 and 180° C., preferably between 100 and 140° C., very preferably between 110 and 140° C.

The operating pressure in the reboiler 5 is generally between 0 and 9 bar.

In one embodiment, the hot flash separation step may be performed under vacuum, meaning that the operating pressure in step f) in the reboiler 5 and the pressure of the flash separation in step g) is strictly between 0 and 1 bar. In this case, the temperature of heating in the reboiler 5 may be lower than 100° C., preferably between 70 and 90° C.

In another embodiment, the operating pressure in the reboiler 5 may be between 1 and 4 bar, and the temperature in the reboiler 5 is between 100 and 140° C., preferably between 110 and 140° C.

In yet a further embodiment, the temperature and the pressure are directly linked via the thermodynamic equilibrium, and so consideration may be given to higher pressures in the flash vessels and the reboiler (pressure greater than 4 bar, especially between 6 and 8 bar, for example) if the solvent is stable thermally or if the degradation of the solvent is second-order (replacing the solvent stock in the plant more frequently is not an economic constraint).

It should be noted that capital expenditure for the plant according to the invention is also limited or even reduced:
relative to a scheme with conventional flash regeneration (without thermal integration), some additional apparatuses are to be considered (one exchanger and one vessel)
relative to a scheme with regeneration by steam stripping, the regeneration column is replaced by a simple vessel.

### EXAMPLE

To illustrate the advantages of the invention in terms of energy consumption, an example is given below for a biogas cleaning scenario.

Table 1 below illustrates the advantages of the present invention for the cleaning of a biogas to biomethane (decarbonation) with a chemical solvent called AE Amine consisting of a mixture of a tertiary polyamine, a tertiary amine and a secondary polyamine, comprising especially 25% by weight of PMDPTA, 11% by weight of MDEA, 4% by weight of piperazine. For this type of application, high-level regeneration by steam stripping is not needed, given the specification for the target CO₂ content (generally 2.5 vol %).

The corollary of partial regeneration of the solvent is an increase in the volume flow of solvent needed to ensure the specification (in the present scenario, +23% relative to high-level regeneration by steam stripping). The capital expenditure remains limited nevertheless, as the stripping column is replaced by a simple vessel and the biogas cleaning units are small in size.

The hot flash regeneration mode according to the invention and the associated thermal integration permit a substantial reduction in the reboiler power needed to regenerate the solvent:
44% relative to the conventional hot flash regeneration mode
30% relative to the regeneration by steam stripping mode

This reduction in energy consumption allows an increase in the biomethane productivity of the methanization site, as the regulation ensures that the heat requirements of the cleaning process are met by self-consumption of the biogas produced.

TABLE 1

| | Steam | Conventional | |
|---|---|---|---|
| | stripping | hot flashing | According |
| | (comparative, | (comparative, | to the |
| Regeneration mode | reference 1) | reference 2) | invention |
| Solvent | AE Amine | AE Amine | AE Amine |
| Solvent flow rate | 16.2 | 20.0 | 20.0 |
| (Sm³/h) expressed in | | +23% | +23% |
| terms of standard | | | |
| conditions (T = | | | |
| 15.6° C.) | | | |
| Alpha depleted = | 0.03 | 0.20 | 0.20 |
| degree of loading of | | | |
| the depleted solvent | | | |
| (mol acidic gases/mol | | | |
| amines) | | | |
| Alpha rich = degree of | 0.46 | 0.55 | 0.55 |
| loading of the rich | | | |
| solvent (mol acidic | | | |
| gases/mol amines) | | | |
| Required reboiler | 0.71 | 0.90 | 0.50 |
| power (kWh/Nm3 | | +26% | −30% (relative |
| biogas) | | | to reference 1) |
| | | | −44% (relative |
| | | | to reference 2) |

1. A method for treating gas by chemical, physical or hybrid absorption of compounds for removal, comprising at least:
a) a step of absorption of said compounds for removal in an absorber (1) by contacting a stream of gas for treatment (101) with a solvent stream, called “depleted solvent” (117), to give a treated gas (102) and a solvent enriched in compounds for removal, called “rich solvent” (103);
b) a step of optional separation of the rich solvent (103) in a medium-pressure flash vessel (2) to desorb the coabsorbed compounds (106) and give a cold rich solvent (104);
c) a step of heat exchange between a fraction (104A) of the cold rich solvent stream (104) and the hot depleted solvent stream (110) in a heat exchanger (3A) to give a reheated rich solvent stream (105A), and a cooled depleted solvent stream (115);
d) a step of heat exchange between the complementary fraction (104B) of the cold rich solvent stream (104) and the hot desorbed gas effluent (112) corresponding to the desorbed gas stream (111) from the flash separation in step g) and to the gaseous compound stream (107) from the optional flash separation in step e) in a heat exchanger (3B) to give a reheated rich solvent stream (105B), and a cooled desorbed gas stream (113);
e) a step of optional separation in a low-pressure flash vessel (4) of the reheated rich solvent streams (105A) and (105B) at the exit of the thermal integration steps, enabling the separation of the gaseous compounds (107), and a rich solvent stream (108);
f) a step of regeneration of the rich solvent (108) by heating in a reboiler (5) to give a biphasic regenerated solvent (109);
g) a step of separation in a low-pressure flash vessel (6) of the biphasic regenerated solvent (109), enabling the separation of a hot depleted solvent stream (110) at a temperature preferably of between 70 and 180° C., very preferably between 110 and 140° C., and a gaseous stream comprising the compounds for removal in desorbed gas form (111);
h) a final cooling of the cooled depleted solvent (115) to give a fully cooled depleted solvent stream (116) ready to be fed again to the absorber (1) in the form of a depleted solvent stream (117).

2. The method as claimed in claim 1, wherein the fraction (104A) of the cold rich solvent stream sent to the heat exchanger (3A) represents between 0.5% and 50% by weight of the total rich solvent stream.

3. The method as claimed in claim 1, wherein the separation in the medium-pressure flash vessel in step b) is performed at a higher pressure than the separation in the low-pressure flash vessel, of between 3 and 10 bar.

4. The method as claimed in claim 1, wherein the separation in the low-pressure flash vessel in steps e) and g) is performed at a pressure of between 0 and 9 bar.

5. The method as claimed in claim 4, wherein the separation in the low-pressure flash vessels in steps e) and g) is performed at the same pressure of between 1 and 4 bar and the separation in the medium-pressure flash vessel in step b) is performed at a pressure of between 5 and 10 bar.

6. The method as claimed in claim 4, wherein the heating in the reboiler in step f) and the separation in the low-pressure flash vessel in step g) are performed at a pressure strictly of between 0 and 1 bar.

7. The method as claimed in claim 6, wherein the temperature in the reboiler is between 70 and 100° C.

8. The method as claimed in claim 4, wherein the operating pressure in the reboiler is between 1 and 9 bar, and wherein the temperature in the reboiler is between 100 and 140° C.

9. The method as claimed in claim 1, wherein the solvent is a chemical solvent comprising at least one amine.

10. The method as claimed in claim 9, wherein the solvent comprises a mixture of tertiary and secondary amines.

11. The method as claimed in claim 1, comprising a step i) of final condensation of the desorbed gas stream (113) with the aim of limiting the water losses in the method, so as to give a stream (114) of cooled desorbed compounds, at a temperature of between 20 and 60° C.

12. The method as claimed in claim 1, wherein the operating pressure in the absorption step a) is between 1 and 80 bar.

13. The method as claimed in claim 1, wherein the gas for treatment is selected from a biogas, a natural gas, a synthesis gas (syngas), or industrial flue gases, for example coal power station, incinerator or blast furnace flue gases.

14. A gas treatment plant allowing implementation of the method as claimed in claim 1, comprising at least:
an absorber (1) allowing the gas for treatment to be contacted with a solvent referred to as “depleted solvent” to give a treated gas and solvent enriched in compounds for removal, called “rich solvent”;
an optional vessel (2) for medium-pressure flashing of the rich solvent to desorb the coabsorbed compounds;
a cold rich solvent/hot depleted solvent heat exchanger (3A);
a cold rich solvent/hot gas effluent heat exchanger (3B);
a conduit for short-circuiting a fraction of the cold rich solvent feeding the cold rich solvent/hot depleted solvent heat exchanger (3A) to the cold rich solvent/hot gas effluent heat exchanger (3B);
an optional low-pressure flash vessel (4) at the exit of the thermal integration steps, enabling the degassing of the rich solvent;
a reboiler (5) enabling heating of the rich solvent;
a low-pressure flash vessel (6), enabling separation of the regenerated solvent and the compounds for removal in desorbed gas form;
an optional final condenser (7) for the desorbed gases, with the aim of limiting the water and solvent losses in the method;
a final cooler (8) for the depleted solvent;
a set of pumps for (depleted and/or rich) solvent (9), enabling the circulation of the solvent.

15. The plant as claimed in claim 14, wherein the heat exchanger (3A) and the heat exchanger (3B) consist of one and the same apparatus.

16. The method according to claim 1, wherein
in a) the solvent stream has a temperature of between 20 and 60° C.,
in b) the cold rich solvent has a temperature of between 40 and 80° C.,
in c) the cooled depleted solvent stream has a temperature of between 45 and 90° C.,
in d) the reheated rich solvent stream has a temperature of between 60 and 170° C. and the cooled desorbed gas stream has a temperature of between 45 and 90° C.,
in e) the separation of the gaseous compounds is performed at a temperature of between 60 and 170° C., and the temperature of the rich solvent stream is between 60 and 170° C.,
in f) f regeneration of the rich solvent is at a temperature between 70 and 180° C.,
in g) the separation of the hot depleted solvent stream is at a temperature between 70 and 180° C., and the gaseous stream is at a temperature between 70 and 180° C., and
in h) the fully cooled depleted solvent stream at a temperature between 20 and 60° C.

17. The method according to claim 16, wherein
in c) the cooled depleted solvent stream has a temperature of between 60 and 90° C.
in d) the reheated rich solvent stream has a temperature of between 100 and 130° C. and the cooled desorbed gas stream has a temperature of between 60 and 90° C.,
in e) the separation of the gaseous compounds is performed at a temperature of between 100 and 130° C., and the temperature of the rich solvent stream is between 100 and 130° C.,
f) a step of regeneration of the rich solvent (108) by heating in a reboiler (5) at a temperature preferably of between 70 and 180° C. to give a biphasic regenerated solvent (109), and
in g) the separation of the hot depleted solvent stream is at a temperature between 110 and 140° C., and the gaseous stream is at a temperature between 110 and 140° C.

18. The method as claimed in claim 1, wherein the fraction (104A) of the cold rich solvent stream sent to the heat exchanger (3A) represents between 5% and 40% by weight of the total rich solvent stream.

19. The method as claimed in claim 1, wherein the separation in the medium-pressure flash vessel in step b) is performed at between 5 and 10 bar.

20. The method as claimed in claim 1, wherein the separation in the low-pressure flash vessel in steps e) and g) is performed at a pressure of between 1 and 4 bar.
